(19) United States
(12) Patent Application Publication
(10) Pub. No.: US 2025/0256545 A1
(43) Pub. Date: Aug. 14, 2025

(54) OPERATING INTERACTIONS BETWEEN ACTUATOR SETS

(71) Applicant: JAGUAR LAND ROVER LIMITED, Warwickshire (GB)

(72) Inventors: Adrian Bouaru, Whitley, Coventry, Warwickshire (GB); Alexander Wojtecki, Whitley, Coventry, Warwickshire (GB)

(21) Appl. No.: 18/702,418

(22) PCT Filed: Oct. 18, 2021
(86) PCT No.: PCT/EP2021/078796

§ 371 Date: Apr. 18, 2024

(51) Int. Cl. B60G 21/055; B60G 17/0185; B60G 17/04; B60G 17/06

(52) U.S. Cl. CPC B60G 21/0555; B60G 17/0185; B60G 17/0416; B60G 17/06; B60G 2202/135; B60G 2202/15; B60G 2202/42; B60G 2400/71; B60G 2400/82; B60G 2500/10; B60G 2500/40; B60G 2600/08; B60G 2800/80; B60G 2800/9122; B60G 2800/94; B60G 2800/962

(57) ABSTRACT

Aspects of the present invention relate to a control system (100, 200) for a vehicle suspension system (300) of a vehicle (600). The control system comprises one or more controllers. The control system is configured to: determine that a first subsystem (302) of the plurality of connected subsystems is operating in a de-rated mode in response to a subsystem operating condition of the first subsystem being outside a predetermined operating window; and in dependence on determining that the first subsystem is operating in the de-rated mode, transmit a de-rate indicator to a further subsystem (304, 306) of the plurality of connected subsystems, wherein the de-rate indicator is configured to: indicate, to the further subsystem, that the first subsystem is operating in a de-rated mode; and cause the further subsystem to operate in a de-rate response mode, wherein the operation of the vehicle suspension system with the first subsystem operating in the de-rated mode and the further subsystem operating in the de-rate response mode provides a higher level of vehicle control in comparison to the vehicle suspension system operating with the first subsystem operating in the de-rated mode without the further subsystem operating in the de-rate response mode.

### TECHNICAL FIELD

The present disclosure relates to energy management and managing operating interactions between subsystems within a vehicle. Aspects relate to a control system, to a system, to a vehicle, to a method, and to computer software.

### BACKGROUND

Vehicles (for example petrol, diesel, electric, hybrid) may comprise active suspension systems, such as active roll control subsystems, active springs subsystems, and/or semi-active damping subsystems, for maintaining vehicle stability and driving attributes at a user level.

Maximum performance of all subsystems may deliver a best overall vehicle attribute performance. However, continuous usage of the maximum performance of all subsystems through a drive cycle may lead to individual subsystems overheating. If left unchecked, overheating in a subsystem could result in reduced subsystem performance and may even lead to a forced shut down of the subsystem. A control action may be taken to pre-emptively reduce subsystem performance with the aim of preventing forced shut down. That is, the subsystem enters a de-rated mode. However, in conventional vehicle systems, there is no communication between the plurality of subsystems present. Therefore, when a first subsystem enters a de-rated mode, the other subsystems are not aware of the operation mode of the first subsystem being de-rated and continue at their own maximum performance mode. This static interaction between the other subsystems then forces the other subsystems to enter into their own de-rated mode, thereby leading to all subsystems to operate in a reduced performance.

Therefore, there is a need for a control system within a suspension system of a vehicle whereby subsystems are able to respond to changes in other subsystems of the overall system, such that subsystems may continue to deliver a best possible vehicle attribute given the circumstances and help prevent de-rated subsystems from having to further degrade their own performance.

It is an aim of examples disclosed herein to address one or more of the disadvantages associated with the prior art.

### SUMMARY OF THE INVENTION

Aspects and embodiments of the invention disclosed herein provide a control system, to a system, to a vehicle, to a method, and computer software, as claimed in the appended claims.

According to an aspect of the present invention there is provided a control system for a vehicle suspension system of a vehicle. The control system comprises one or more controllers. The control system is configured to: determine that a first subsystem of the plurality of connected subsystems is operating in a de-rated mode in response to a subsystem operating condition of the first subsystem being outside a predetermined operating window; and in dependence on determining that the first subsystem is operating in the de-rated mode, transmit a de-rate indicator to a further subsystem of the plurality of connected subsystems, wherein the de-rate indicator is configured to: indicate, to the further subsystem, that the first subsystem is operating in a de-rated mode; and cause the further subsystem to operate in a de-rate response mode, wherein the operation of the vehicle suspension system with the first subsystem operating in the de-rated mode and the further subsystem operating in the de-rate response mode provides an improved vehicle control in comparison to the vehicle suspension system operating with the first subsystem operating in the de-rated mode without the further subsystem operating in the de-rate response mode.

The de-rate response mode of the further subsystem may be different from a de-rated mode of that further subsystem, were that further subsystem to enter a de-rate mode as a result of the further subsystem's internal operating condition being outside a predetermined operating window. That is, a subsystem may operate differently operating in a de-rated state itself, compared with operating in a de-rate response state in response to another subsystem operating in a de-rated state. There may be a plurality of de-rated modes with increasing severity of performance degradation. In order to react proportionally to how far from the normal operating window the operational state of the first subsystem is, the control system or the first sub-system may be further configured to determine the most appropriate de-rate mode for the first subsystem.

The de-rate indicator may be configured to: indicate, to the further subsystem, that the first subsystem is operating in a de-rated mode and which de-rated mode of a plurality of available de-rated modes the first subsystem is operating in; and cause the further subsystem to operate in a de-rate response mode in dependence thereon.

The plurality of subsystems may be variously electrically and/or mechanically connected.

The control system may be further configured to cause the further subsystem to operate in a de-rate response mode by: determining at least one subsystem operating window for the further subsystem, wherein the further subsystem, operating in dependence on the at least one subsystem operating window, operates in the de-rate response mode; and providing the at least one subsystem operating window to the further subsystem to cause the further subsystem to operate in the de-rated response mode according to the subsystem operating window. The at least one subsystem operating window for the further subsystem may be determined in dependence on one or more of: a de-rate state of the first subsystem, a vehicle suspension system temperature, and one or more vehicle operation conditions. Such factors may be indicated in plural signals which may be system operation driven, or may be specific configuration parameter changes hosted in the control system.

The control system may be further configured to cause the further subsystem to operate in a de-rate response mode by: determining a subsystem de-rate response mode for the further subsystem; and providing the determined de-rate response mode to the further subsystem to cause the further subsystem to operate in the determined de-rated response mode.

The control system may be further configured to determine the at least one subsystem operating window by identifying the at least one subsystem operating window in a look-up matrix, wherein the look-up matrix indicates, for at least one de-rated mode of the first subsystem, a corresponding subsystem operating window for provision to the further subsystem to cause the further subsystem to operate in the de-rate response mode.

The control system may be further configured to determine the de-rate response mode by identifying the at least one subsystem de-rate response mode in a look-up matrix, where the look-up matrix indicates, for at least a de-rated mode of the first subsystem, a corresponding further subsystem de-rated response mode. There may be a plurality of de-rated response mode for the further subsystem for a particular de-rated mode of the first subsystem.

The look-up matrix in some examples may be any non-linear mapping function. In some examples the look-up matrix may be configured to adapt over time, for example, the look up matrix entries (i.e. indications of the de-rate response modes each further subsystem may enter into) may adapt in response to a prior action taken, and a measure of effectiveness of that action, for example. Such adaptation may comprise use of artificial intelligence to determine how the look-up matrix entries may adapt to improve the overall response of the vehicle suspension system.

The control system may be further configured to determine the at least one subsystem operating window in dependence on at least one vehicle environment parameter, indicating one or more of: a driving surface type on which the vehicle is located; an operating temperature of the vehicle suspension system; an operating electrical condition of the vehicle suspension system.

For example, the driving surface type may be, in the UK, a motorway, an A road, a B road, a race track, off-road, water or a ford. Other geographic locations may have different road classifications which provide different driving surface types. As another example, the operating electrical condition of the vehicle suspension system may be a voltage, a current, and/or a power of a subsystem.

The control system may be further configured to cause the further subsystem to operate in a de-rate response mode causing the further subsystem to change operation mode to gradually operate in the de-rate response mode over a period of time. The control system may be configured to cause the further subsystem to gradually move to operating in the de-rate response mode over a finite time. In other words, the change in operational mode may blend from one to another gradually.

The control system may be further configured to: determine that the first subsystem has completed operating in the de-rated mode in response to a subsystem operating condition of the first subsystem being within the predetermined operating window; and in dependence on determining that the first subsystem has completed operating in the de-rated mode, transmit a normal operation indicator to the further subsystem, wherein the normal operation indicator is configured to cause the further subsystem to operate the operating mode it was operating in prior to operating in the de-rate response mode.

The control system may be further configured to determine that the first subsystem is operating in the de-rated mode by receiving a de-rate indicator from the first subsystem, the de-rate indicator indicating that the subsystem operating condition of the first subsystem is outside a predetermined operating window.

The control system may be further configured to determine that the first subsystem has completed operating in the de-rated mode by receiving a normal operation indicator, from the first subsystem, indicating the first subsystem is operating in an operating mode in which the subsystem operating condition of the first subsystem is within the predetermined operating window. The subsystem operation condition may be comparable to the subsystem operation condition before the de-rate response mode was entered.

The higher level of vehicle control may comprise the vehicle suspension system operating at one or more of: reduced power consumption; reduced temperature (for example reduced local component temperature); increased availability of one or more of the subsystems within the plurality of connected subsystems of the vehicle suspension system; and reduced component loads. The higher level of vehicle control may be improved vehicle control, for example improved vehicle body and/or wheel control.

The control system may be further configured to periodically determine the operating mode of each of the plurality of connected subsystems.

The control system may determine that the first subsystem should move into a de-rated mode independently of receiving an indication from the first subsystem that the subsystem should move into a de-rated mode, and cause the first subsystem to operate in the derated mode.

The plurality of connected subsystems may comprise at least one electronic control module, and at least one mechatronic component.

One or more of the first subsystem and the further subsystem may be: an electronic active roll control system of the vehicle suspension system; an active damping system of the vehicle suspension system; a rear wheel steering system; an active springs system of the vehicle suspension system; an active steering system of the vehicle suspension system; and an active suspension system of the vehicle suspension system.

The control system may be further configured to cause the further subsystem to operate in a de-rate response mode by: providing a de-rate response mode indicator to the further subsystem, wherein the de-rate response mode indicator indicates, to the further subsystem, that the further subsystem is to change operation mode to operate in the de-rate response mode and that one or more of the control system and the further subsystem is to determine a subsystem operating window to achieve in the de-rate response mode.

In a further aspect there is provided a system comprising: a control system disclosed herein and a plurality of connected subsystems. Sets of subsystems in the plurality of subsystems may be variously connected mechanically, electrically, or electromechanically/mechatronically.

In a further aspect there is provided a method, comprising: determining that a first subsystem of a plurality of connected subsystems of a suspension system in a vehicle is operating in a de-rated mode in response to a subsystem operating condition of the first subsystem being outside a predetermined operating window; and in dependence on determining that the first subsystem is operating in the de-rated mode, transmitting a de-rate indicator to a further subsystem of the plurality of connected subsystems, wherein the de-rate indicator is configured to: indicate, to the further subsystem, that the first subsystem is operating in a de-rated mode; and cause the further subsystem to operate in a de-rate response mode, wherein the operation of the vehicle suspension system with the first subsystem operating in the de-rated mode and the further subsystem operating in the de-rate response mode provides a higher level of vehicle control in comparison to the vehicle suspension system operating with the first subsystem operating in the de-rated mode without the further subsystem operating in the de-rate response mode.

In a further aspect there is provided computer readable instructions which, when executed by a processor of any control system disclosed herein, are arranged to perform any method disclosed herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a controller of a control system according to examples disclosed herein;

FIG. 2a shows a controller and actuator set of a control system for a vehicle suspension system according to examples disclosed herein;

FIG. 2b shows a control system for a vehicle suspension system according to examples disclosed herein;

FIG. 2c shows a control subsystem for a vehicle suspension system according to examples disclosed herein;

FIG. 3a-3d shows energy management and interactions between subsystems according to examples disclosed herein;

FIG. 4a-4b shows vehicle attributes and subsystem availability as a result of energy management and interactions between subsystems according to examples disclosed herein;

FIG. 5 shows a method according to examples disclosed herein; and

FIG. 6 shows a vehicle according to examples disclosed herein.

### DETAILED DESCRIPTION

Examples discussed herein provide a control system for a suspension system for use, for example, in the automotive industry. Active suspension systems may utilise mechatronic systems (MS) which may include a cascade of;
(a) high level vehicle control generating system demand signals (for example torque demand) to influence vehicle motion;
(b) low level control providing control signals to the actuator(s) (motor control etc) to deliver the demanded signal from the high level control; and
(c) motor/hydraulic and associated mechanical components to deliver the physical manifestation of the demanded signal.

The performance of the combination of steps (b) and (c) may be influenced by a plurality of control parameters/boundary conditions. For example, they may be boundary conditions for; a maximum motor speed, a motoring current, a regeneration current, one or more scalars applied to feed forward signals, a supplied voltage, and a motor temperature.

Considering different types of vehicle usage (for example on-road vs off-road) and varying physical conditions of the MS (for example for example temperature), the optimal settings for the control parameters/boundary conditions may differ (as may the most important performance metrics).

Within a vehicle there may be a plurality of such MSs (sub-systems of the vehicle) that, through their interaction, deliver a desired vehicle level attribute (which may be perceived as vehicle dynamics, thermal availability and power consumption). There may be a plurality of configurations of the constituent MSs that deliver the same attribute. The optimum configuration may be a function of the vehicle use case and the states of the individual MSs. There may be a case where the optimum configuration of MSs for the vehicle level is delivered by sub-optimal local configurations of the individual MSs.

Conventional system interactions may be configured in a static manner to deliver a reasonable compromise between all use cases, performance metrics and sub-system states. This inevitably leads to reduced performance for individual use cases or sub-system states compared to the best possible local optimum, had a global compromise not been necessary.

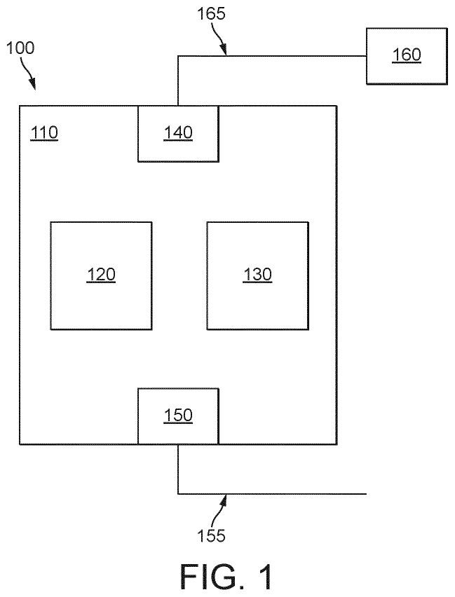

With reference to FIG. 1, there is illustrated a control system 100 for a vehicle. The control system 100 as illustrated in FIG. 1 comprises one controller 110, although it will be appreciated that this is merely illustrative and in other examples the control system 100 may comprise more than one controller 110. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 130 may comprise an electrical input 140 of the controller 110. The output means may comprise an electrical output 150 of the controller 110. The input 140 is arranged to receive one or more input signals 165, for example from a sensor 160. There may be one or more sensors which provide information to the controller input 140. The output 150 is configured to provide one or more output signals 155.

In an example, the control system 100 may be for a vehicle suspension system of a vehicle. The control system 100 may comprise one or more controllers 110. The control system 100 may be configured to determine that a first subsystem of the plurality of connected subsystems is operating in a de-rated mode in response to a subsystem operating condition of the first subsystem being outside a predetermined operating window. For example, the control system 100 may determine that a subsystem may no longer be able to perform at a maximum capability due to a temperature of the subsystem exceeding a factory set window (i.e. a predetermined threshold).

The control system 100 may be configured to, in dependence on determining that the first subsystem is operating in the de-rated mode, transmit a de-rate indicator to a further subsystem of the plurality of connected subsystems. The de-rate indicator in some examples may indicate, to the further subsystem, that the first subsystem is operating in a de-rated mode and also which de-rated mode of a plurality of available de-rated modes the first subsystem is operating in. The de-rate indicator may therefore be configured to cause the further subsystem to operate in a de-rate response mode in dependence on the de-rated mode in which the first subsystem is operating, and which de-rated mode of a plurality of available de-rated modes the first subsystem is operating in. Thus the further subsystem is caused to operate in a de-rate response mode in dependence on the first subsystem entering a de-rated mode, and which particular de-rated mode of a plurality of possible de-rated modes the first subsystem is operating in.

Sets of subsystems in the plurality of subsystems may be variously connected mechanically, electrically, or electromechanically/mechatronically. That is, the sets of subsystems in the plurality of subsystems may be at least one electronic control module, and at least one mechatronic component (wherein a mechatronic component is a component having an electrical aspect as well as a mechanical aspect). In some examples, the plurality of subsystems may be any number of electronic control units of a vehicle. For example, at least one pair of subsystems may have mechanical interactions between them. At least one pair of subsystems may be connected to a vehicle power supply such as a 12V/48V supply and may thus be considered to be indirectly electrically connected. Certain subsystems may be directly electrically connected.

In some examples, the control system 100 may be configured to determine that the first subsystem is operating in the de-rated mode by receiving the de-rate indicator from the first subsystem 302. The de-rate indicator may be configured to indicate, to the further subsystems 304, 306, that the first subsystem is operating in a de-rated mode. For example, the de-rate indicator may indicate that the subsystem operating condition of the first subsystem is outside a predetermined operating window. That is, once a subsystem enters a de-rated mode, further subsystems are notified, via the de-rate indicator, to become aware that the subsystem is in a de-rated mode and can therefore no longer perform at a maximum capability. The de-rate indicator may in addition be configured to cause the further subsystem(s) to operate in a de-rate response mode, wherein the operation of the vehicle suspension system with the first subsystem operating in the de-rated mode and the further subsystem operating in the de-rate response mode provides a higher level of vehicle control in comparison to the vehicle suspension system operating with the first subsystem operating in the de-rated mode without the further subsystem operating in the de-rate response mode. That is, when the further subsystem becomes aware that the first subsystem is in a de-rated mode, and can no longer perform at a maximum capability, the further subsystem may adapt its behaviour such that the de-rated first subsystem may be made available sooner, or may remain available for longer, than if the further subsystem had not entered the de-rate response mode. This may therefore improve the availability of the de-rated first subsystem and may improve the overall availability of the suspension system as a whole.

By adapting, the further subsystem may also de-rate in some cases, or may “up-rate” in some cases, or may otherwise change their operational state, so as to perform in a de-rate response mode and compensate, or take account of the operation of the first subsystem. The de-rate indicator may be configured in some examples to: indicate, to the further subsystem, both that the first subsystem is operating in a de-rated mode and which de-rated mode of a plurality of available de-rated modes the first subsystem is operating in. Thus the further subsystem can, in dependence on the de-rate indicator, operate in a de-rate response mode in dependence on the behaviour of the first subsystem, to achieve a better vehicle operation than may be achieved if there was no interaction or communication between the first and further subsystems—for example if the further subsystem did not change its operating state at all in response, or if the further subsystem responded by changing its operating state to a default de-rated mode regardless of what the first subsystem is actually doing other than not operating as expected.

The de-rate response mode of the further subsystem may be different from a de-rated mode of that further subsystem, were that further subsystem to enter a de-rate mode as a result of the further subsystem's internal operating condition being outside a predetermined operating window. That is, a subsystem may operate differently operating in a de-rated state itself, compared with operating in a de-rate response state in response to another subsystem operating in a de-rated state. There may be a plurality of de-rated modes with increasing severity of performance degradation. In order to react proportionally to how far from the normal operating window the operational state of the first subsystem is, the control system or the first sub-system may be further configured to determine the most appropriate de-rate mode for the first subsystem.

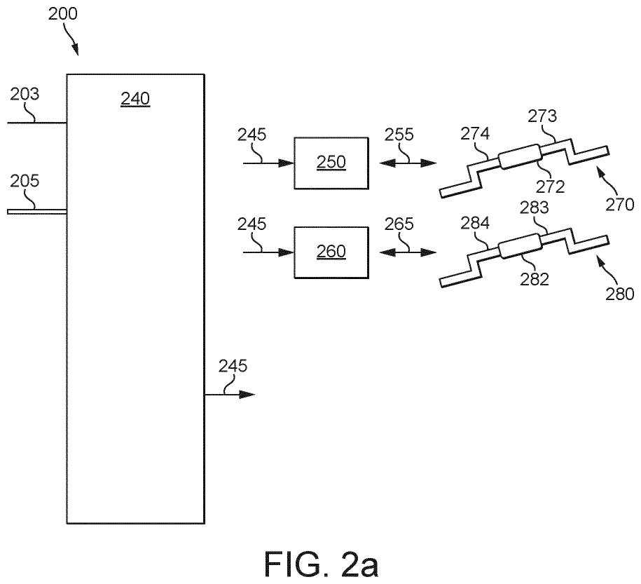

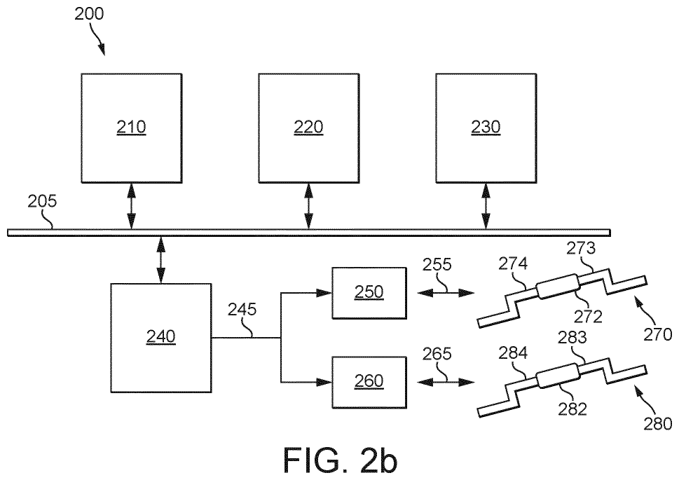

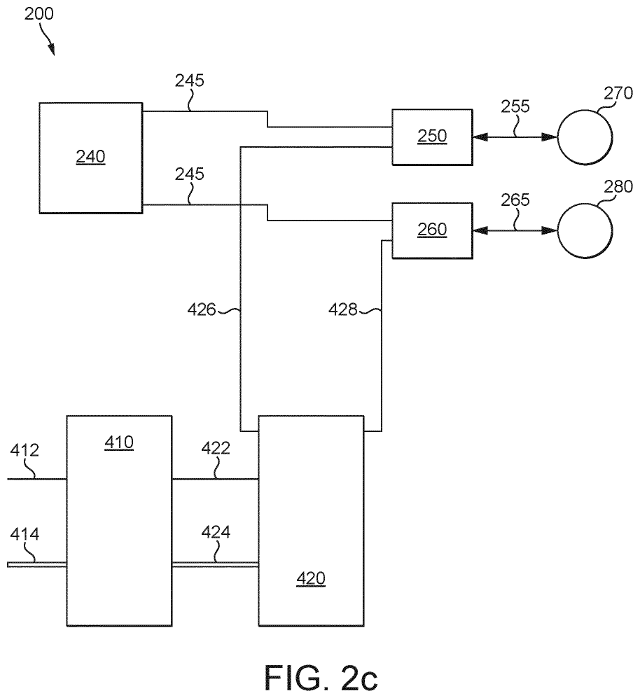

FIGS. 2a and 2b illustrate an example control system for a suspension system of a vehicle. A suspension system of a vehicle may comprise anti-roll bars which are controlled using an anti-roll control system. The anti-roll control system acts to control the anti-roll bars, to control a roll of a body of the vehicle and reduce the impact of disturbances from a road surface. The anti-roll control system may be electromechanical and/or hydraulic. Anti-roll bars may typically comprise stabiliser bars, typically metal, which join the vehicle suspension on either side of the vehicle axle, usually through drop links, and connect to a rotational actuator situated between the mounting points to the vehicle chassis. Each side of the anti-roll bar is able to rotate freely when a motor of the anti-roll control system is not energised. When the motor control is enabled (i.e., delivering torque), the anti-roll bar may act as a torsional spring. The anti-roll bars may be controlled to compensate for some vehicle movements such as body roll, for example from driving around a corner. Body roll can cause the wheels at the side of the vehicle outside the turn to reduce their contact with the road surface. Anti-roll bars may be controlled to counteract this effect and reduce the body roll effect, by transferring at least part of the additional load on the wheels at the side of the vehicle inside the turn to those wheels at the outside, for example by providing a torsional effect to pull the wheels towards the chassis and even out the imbalance in load on the wheels caused by cornering.

A typical suspension system may comprise passive front and rear anti-roll bars provided respectively between the front and rear pairs of wheels of a standard four-wheel vehicle. In a vehicle with an active roll control system, an anti-roll bar may respectively comprise two anti-roll bar ends 273, 274; 283, 284 connected together by a central housing having an actuator 272, 282. The central housing may additionally have one or more of a gearbox, sensors, and dedicated actuator controllers. The actuator 272, 282 acts to provide an actively controlled torque rather than a fixed torsional stiffness provided by passive anti-roll bars. One or more sensors may monitor the movement of the vehicle, and provide the sensed parameters as input to the active roll control system to control the actuator and provide a suitable torque to the anti-roll bar. The two ends of the anti-roll bar 273, 274; 283, 284 may be identical, or may be non-identical.

FIG. 2a shows an example control system 200 for a suspension system a vehicle, communicatively connected to front and rear anti-roll bars 270, 280. The control system 200 comprises a controller 240 which is connected by a bidirectional communication channel 245 to anti-roll bar controllers 250, 260 configured to respectively control front and rear anti-roll actuators 272, 282. The controller 240 may be the controller 110 of FIG. 1. The controller 240 may comprise one or more of the controllers 110 of FIG. 1. In an example, the controller 240 may be a master controller for an electronic active roll control system in the vehicle. The controller 240 may host a vehicle level control strategy and actuation control for the electronic active roll control system in the vehicle.

The controller 240 may be configured to receive one or more sensor signal 203 from one or more sensors attached to the vehicle. The one or more sensor signal 203 may comprise, for example: a signal from a a respective suspension height sensor of the vehicle suspension; a signal from a respective hub acceleration sensor of the vehicle; and a signal from a respective torque demand sensor for the anti-roll bar actuators 272, 282. A signal from a respective motor position sensor for the anti-roll bar actuators 272, 282 may be communicated to the controller 240 via the communication link 245The respective suspension height sensor may be configured to determine a sensor signal indicative of one or more of a height of a left side and a height of a right side (for example at the individual wheels) of the vehicle suspension. The respective motor position sensor may be configured to determine a sensor signal indicative of a position of a respective motor of the anti-roll bar actuators 272, 282. The respective hub acceleration sensor may be configured to determine a sensor signal indicative of an acceleration of one or more hub of a wheel of the vehicle. The torque sensor may provide a measure of an existing torque generated in the system, as a result of a target torque demand being requested by the controller 240.

The controller 240 may be configured to receive one or more communication signal via a communications bus 205.

The communications bus 205 may be configured to deliver data to the controller 240 from other subsystems within the vehicle. For example, the communications bus 205 may be configured to communicate a signal indicating a status of one or more modules 210, 220, 230 that are in communicative connection with the controller 240 to the controller 240. In another example, the communications bus 205 may be configured to communicate a command from the controller 240 to the one or more modules 210, 220, 230 that are in communicative connection with the controller 240. The one or more modules 210, 220, 230, are discussed further in relation to FIG. 2b below. Signals transmitted over connections 203 or 245 may alternatively or additionally be transmitted over communications bus 205.

The controller 240 may be configured to generate system demand signals to influence a vehicle's motion via the anti-roll actuators 272, 282. An actuator provided between a front pair of wheels of a vehicle may be called a front actuator. A front active roll control (FARC) module may be electrically connected to the front actuator, and may comprise the controller 250 to control the front actuator 272. Similarly, an actuator provided between a rear pair of wheels of a vehicle may be called a rear actuator. A rear active roll control (RARC) module may be electrically connected to the rear actuator and may comprise a controller 260 to control the rear actuator 282.

The front and rear anti-roll actuators 272, 282 comprises an electric motor which is controllable by the respective anti-roll controller 250, 260. Each of the front and rear anti-roll actuators 272, 282 may be controlled by its own respective anti-roll controller in some examples, or multiple anti-roll actuators may be controlled by a common anti-roll controller in some examples. Each of the anti-roll actuators 272, 282 may be individually controlled in some cases to improve the management of the roll of the body of the vehicle. The front and rear anti-roll actuators 272, 282 may be controlled by a control signal which is generated by the controller 240. The controller may generate and output this control signal through the output channel 245 to the anti-roll bar controllers 250, 260, which then use the communication channel 245 to exchange data with the controller 240. The control signal may carry instructions to be implemented by the actuator, for example by providing a torque via a torque demand to apply to the anti-roll bar. For example, as discussed above, when the vehicle is cornering, a control signal may be transmitted to the anti-roll bar controllers 250, 260, which may in turn transmit a control signal via the interface 255, 265, so that the front and rear anti-roll actuators 272, 282 may mitigate a body roll effect. Similarly, anti-roll bar controllers 250, 260 may transmit measured values from the anti-roll actuators to the controller 240 through output channel 245.

FIG. 2b shows an example control system 200 for a vehicle comprising one or more modules 210, 220, 230, a controller 240 and front and rear anti-roll bars 270, 280. As in FIG. 2a, the control system 200 comprises a controller 240 which is connected by a bidirectional communication channel 245 to controllers 250, 260 configured to respectively control front and rear anti-roll bar actuators 272, 282. Further, the controller 240 of the control system 200 is in a communicative connection to the one or more modules 210, 220, 230 via a communications bus 205. The one or more modules 210, 220, 230 may be configured to perform functions relating to power supply of the suspension system. Module 210 may be a power control module configured to control to a power supply system for the suspension system. Module 220 may be a conversion module configured to convert electrical energy output from the vehicle power supply system. In an example, the conversion module 220 may be a DC-DC converter. Module 230 may be a capacitor module configured to store electrical energy for the suspension system. In an example, the capacitor module 230 may comprise one or more of a capacitor, a super capacitor, and a battery, configured to stored electrical energy from the power supply system for the suspension system. Together, conversion module 220 and capacitor module 230 may be configured to supply electrical energy to the controllers 250, 260, such that the anti-roll bar actuators 272, 282 can be actuated. FIG. 2b illustrating modules 210, 220, 230 as individual modules. However, there may be examples whereby components within the modules 210, 220, and 230 are included in a single module.

FIG. 2c shows an example control system 200 for a vehicle suspension system. Controller 240 is present as in FIGS. 2a-2b, which is connected by a communication channel 245 to anti-roll bar controllers 250, 260 configured to respectively control front and rear anti-roll actuators 272, 282. Also shown in FIG. 2c is a power converter module 410 and an electrical energy storage module 420. The power converter module 410 may comprise, for example, a bidirectional DCDC power converter The electrical energy storage module 420 may comprise a supercapacitor energy storage module in some examples. The power converter module 410 may receive energy from a vehicle battery via power connection 412. The power converter module 410 may receive control inputs via communications bus 414. The electrical energy storage module 420 may receive energy from the power converter module 410 via power connection 422. The electrical energy storage module 420 may receive control inputs via communications bus 424. The electrical energy storage module 420 is also in electrical connection with the anti-roll bar controllers 250, 260 via respective connections 426, 428.

It will be appreciated that the control systems 200 of FIGS. 2a-2c may comprise one or more further connected controllers in some examples, and/or one or more further electrical or communication connections.

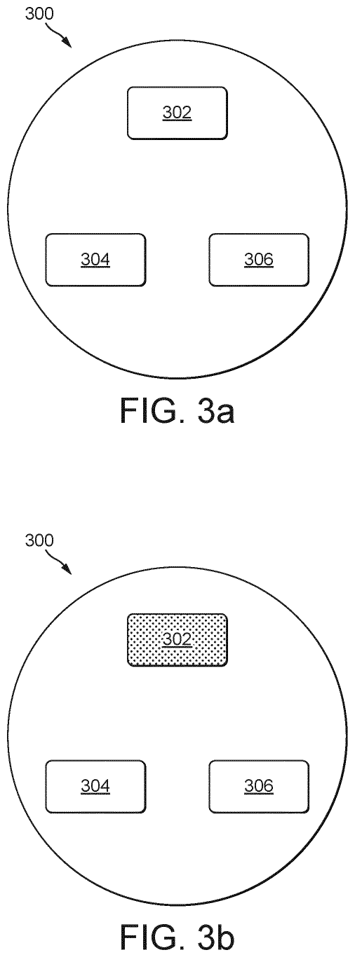

FIGS. 3a-3c show a schematic example of a suspension system 300 within a vehicle. The suspension system 300 may comprise one or more subsystems 302, 304, 306. Each subsystem within the one or more subsystems 302, 304, 306 may be configured to communicate directly with the other one or more subsystems 302, 304, 306. For example, the subsystems 302, 304, 306 may communicate an operational condition with one another using the communication bus, as is discussed in FIGS. 2a-2c, above. In some examples, the communications between the one or more subsystems 302, 304, 306 are routed through the controller 240 such that the controller 240 may monitor the operating condition of each of the one or more subsystems 302, 304, 306. The operating condition of each subsystem may therefore be labelled as a subsystem operating condition.

Each of the subsystems 302, 304, 306 may be configured to control a different component within the suspension system 300. For example, a first subsystem 302 may be the active roll control system, discussed above in FIGS. 2a-2c. As another example, a further subsystem 304, 306 may be a semi-active damping system of the vehicle, a rear wheel steering system; an active springs system of the vehicle, an active steering system, or an active suspension system. That is, the one or more of the first subsystem and the further subsystem may be: an electronic active roll control system of the vehicle suspension system; an active damping system of the vehicle suspension system; and an active springs system of the vehicle suspension system; an active steering system of the vehicle suspension system; and an active suspension system of the vehicle suspension system. Of course in other examples there may be more or fewer such subsystems. Not all subsystems available in the vehicle may necessarily be interconnected as described herein for collaborative reactive operation.

FIGS. 3a-3c show different scenarios of conventional suspension systems for a vehicle. In FIG. 3a, a plurality of subsystems 302, 304, 306 operate at respective maximum performances. In one example, one of the subsystems may enter a de-rated mode as shown in FIG. 3b. Here, a first subsystem 302 enters a de-rated mode, while the further subsystems 304, 306 continue to operate in the state to be able to operate at a respective maximum performance, and make no adjustments to the first subsystem 302 entering the de-rated mode. Operating in this way may cause problems because the further subsystems 304, 306 have not adapted to the change in operation of the first subsystem which may cause them to, for example, run at a higher temperature to compensate. In another alternative example, a first subsystem 302 enters a de-rated mode, and in response, all the further subsystems 304, 306 also enter a de-rated mode in response to the changed state of the first subsystem 302 to a de-rated state of operation. The result is shown in FIG. 3c, wherein all of the subsystems 302, 304, 306 within the suspension system 300 de-rate their performance. Operating in this way may cause problems because it is assumed that if the first subsystem is operating in a de-rated mode then all others should to—in fact there may be a better way of the subsystems all working in response to the first de-rated subsystem operation for better overall vehicle operation. That is, a de-rate response mode of a further subsystem may be different from a de-rated mode of that further subsystem if it was that that further subsystem which first entered a de-rated mode. That is, a subsystem may operate differently operating in a de-rated state itself, compared with operating in a de-rate response state in response to another subsystem operating in a de-rated state.

FIG. 3d shows an example according to the invention disclosed herein. The control system 100, 200 is configured to determine that the first subsystem 302 of the plurality of connected subsystems is operating in a de-rated mode in response to a subsystem operating condition of the first subsystem being outside a predetermined operating window. The control system may determine that the first subsystem should move into a de-rated mode independently of receiving an indication from the first subsystem that the subsystem should move into a de-rated mode, and cause the first subsystem to operate in the derated mode in some examples. In some examples, account may be taken for there being a plurality of possible de-rated modes in which a further subsystem can operate, with different levels of overall performance degradation. In order to react proportionally to how far from the normal operating window the operational state of the first subsystem is, the control system or the first subsystem may be configured to determine the most appropriate de-rate mode for the first subsystem.

In dependence on determining that the first subsystem 302 is operating in a de-rated mode the control system 100, 200 is configured to transmit a de-rate indicator to a further subsystem 304, 306 of the plurality of connected subsystems. The de-rate indicator is configured to: indicate, to the further subsystem, that the first subsystem 302 is operating in a de-rated mode (and in some examples, indicate which de-rated mode of a plurality of possible de-rated modes the first subsystem 302 is operating in). Further, in dependence on determining that the first subsystem 302 is operating in the de-rated mode the control system is configured to cause the further subsystem 304, 306 to operate in a de-rate response mode. As such, the operation of the vehicle suspension system 300 with the first subsystem 302 operating in the de-rated mode and the further subsystem 304, 306 operating in the de-rate response mode provides a higher level of vehicle control, and in some examples an improved availability of the first subsystem, in comparison to the vehicle suspension system 300 operating with the first subsystem 302 operating in the de-rated mode without the further subsystem 304, 306 operating in the de-rate response mode. That is, when a subsystem 302 enters the de-rated mode, the further subsystems 304, 306 within the suspension system 300 adapt their behaviour to attempt to maintain a desired compromise between vehicle attributes.

The control system 100, 200 may be configured to cause the further subsystem 304, 306 to operate in the de-rate response mode by determining at least one subsystem operating window for the further subsystem 304, 306, wherein the further subsystem 304, 306, operating in dependence on the at least one subsystem operating window, operates in the de-rate response mode. The control system 100, 200 may be configured to provide the at least one subsystem operating window to the further subsystem 304, 306 to cause the further subsystem to operate in the de-rate response mode. In some examples, the at least one subsystem operating window may comprise multiple signals which are system operation driven, or specific configuration parameter changes hosted in the controller 100, 200. For example, the multiple signals may comprise one or more of: de-rate state, system temperature, and vehicle conditions. In some examples, the control system 100, 200 may be configured to cause the further subsystem 304, 306 to operate in the de-rate response mode by providing a de-rate response mode indicator to the further subsystem 304, 306. The de-rate response mode indicator may indicate, to the further subsystem 304, 306, that the further subsystem 304, 306 is to change operation mode to operate in the de-rate response mode. One or more of the control system 100, 200 and that the further subsystem 304, 306 is to determine a subsystem operating window to achieve in the de-rate response mode. In some examples, the control system 100, 200 may determine and provide the at least one subsystem operating window for the further subsystem 304, 306 together with the de-rate response mode indicator. That is, the control system 100, 200 may provide the de-rate response mode indicator and the at least one subsystem operating window to the further subsystem 304, 306, such that the further subsystem 304, 306 itself is not required to determine the subsystem operating window. In other examples, the control system may provide the de-rate response mode indicator to the further subsystem and the further subsystem is configured to determine the subsystem operating window to achieve in the de-rate response mode itself.

The control system 100, 200, or in some cases, the further subsystem 304. 306, may be configured to determine the at least one subsystem operating window by identifying the at least one subsystem operating window in a look-up matrix. The look-up matrix may indicate, for at least one de-rated mode of the first subsystem 302, a corresponding subsystem operating window for provision to the further subsystem 304, 306 to cause the further subsystem 304, 306 to operate in the de-rate response mode. The data within the look-up matrix may map a de-rated mode of the first subsystem 302 to the appropriate corresponding subsystem operating window for the further subsystem 304, 306. In an example, the data within the look-up table may be based on historical data. In some examples, the look-up matrix may be adaptive, in that a previous vehicle response to an action taken following a subsystem derating may be taken into account to change a subsequent action taking following the same or similar derating of the same subsystem. In some examples, adaptation of the look-up matrix may be performed using machine learning.

Alternatively, the control system 100, 200 may be configured to directly determine the at least one subsystem de-rate response mode by identifying the at least one subsystem de-rate response mode in a look-up matrix. The look-up matrix may indicate, for at least one de-rated mode of the first sub-system 302, a corresponding sub-system de-rated response mode for provision to the further sub-system 304,306, to cause the subsystem 304, 306 to operate in the de-rate response mode. The data within the look-up matrix may map a de-rated mode of the first subsystem 302 to the appropriate corresponding de-rate response mode for the further subsystem 304, 306.

In some examples, the control system 100, 200 may be configured to compare the subsystem operating condition of the first subsystem 302 to the predetermined operating window. The control system 100, 200 may be configured to determine a de-rate index for the subsystem based on the comparison between the subsystem operating condition of the first subsystem 302 and the predetermined operating window. That is, the de-rate index may be used by the control system 100, 200 to indicate how severe the de-rated mode of the first subsystem 302 is. In some examples, the look-up matrix may use the de-rate index to determine an appropriate subsystem operating window.

The control system 100, 200 may be configured to determine the at least one subsystem operating window in dependence on at least one vehicle environment parameter, indicating one or more of: a driving surface type on which the vehicle is located; an operating temperature of the vehicle suspension system (for example an ambient operating temperature of the vehicle suspension system, or a local component operating temperature of a subsystem within the vehicle suspension system); and an operating electrical condition of the vehicle suspension system. Additionally, the control system 100, 200 may be configured to determine the at least one subsystem operating window in dependence on at least one driver-related input. That is, the control system 100, 200 takes account of a vehicle use case when determining the at least one subsystem operating window. As such, the control system 100, 200 may arbitrate between subsystems to deliver an optimal performance at the vehicle level for a wide range of conditions.

The driving surface type on which the vehicle is located may be, for example: on road or off road. For example, on road in the UK may be a motorway, an A road, a B road, a race track, and/or, a ford (of course in other geographical locations there may be different road classifications providing different driving surface types). For example, off road may be grass, gravel, snow, sand and/or rocks. For example, the control system may determine that the vehicle is located on a race track when encountering a de-rated mode for an electronic active roll control subsystem. In response, the control system 100, 200 may determine the at least one subsystem operating window for a suspension damping subsystem to be more firm in response.

The operating electrical condition of the vehicle suspension system may be one or more of an operating voltage of the subsystem 302, 304, 306, an operating current of the subsystem 302, 304, 306, and a power consumption of the subsystem 302, 304, 306. For example, the control system 100, 200 may determine that the power consumption of a further subsystem (active springs subsystem or a semi-active damping subsystem) is nearing a maximum level when encountering a de-rated mode for an electronic active roll control subsystem. In response, the control system 100, 200 may determine the at least one subsystem operating window such that the further subsystem operates with a power consumption 30% lower than its maximum rated power consumption level.

The driver related input may relate to an input relating to one or more driver selectable modes. For example, the driver selectable modes may relate to an attribute for the vehicle such as: sport, comfort, and/or eco.

As an example the driving surface type on which the vehicle is located; the operating temperature of the vehicle suspension system; and the operating electrical condition of the vehicle suspension system may be determined using the one or more sensors comprised within the vehicle.

The control system 100, 200 may be considered to cause the further subsystem 304, 306 to operate in a de-rate response mode causing the further subsystem 304, 306 to change operation mode to gradually operate in the de-rate response mode over a period of time. That is, once the further subsystem 304, 306 is configured to operate in the de-rate response mode, the control system 100, 200 does not immediately control the further subsystem 304, 306 to operate in the de-rate response mode. The control system 100, 200 may instead cause the further subsystem 304, 306 to gradually move to operating in the de-rate response mode over a finite time, i.e. to gradually blend the operating mode of the further subsystem 304, 306 from the previous operating mode to the de-rate response mode. This ensures that entering the de-rate response mode does not abruptly change the vehicle attributes and cause concern for a user.

The control system 100, 200 may be configured to determine that the first subsystem 302 has completed operating in the de-rated mode. The control system 100, 200 may be configured to determine that the first subsystem 302 has completed operating in the de-rated mode in response to a subsystem operating condition of the first subsystem 302 being within the predetermined operating window. For example, if the temperature of an electronic active roll control subsystem no longer exceeds a temperature operating window, the control system 100, 200 may determine that the electronic active roll control subsystem is no longer in a de-rated mode. That is, the de-rated mode may continue to remain active whilst the conditions determining the de-rated mode are true. Thus, the overall system operates in a continuous manner, and a subsystem may enter a de-rate mode. This de-rate operational mode may continue to remain active whilst the conditions determining the mode are true. Mode changes, such as a further subsystem moving into a de-rate response mode, a first subsystem moving out of a de-rated mode, and a further subsystem moving out of a de-rate response mode may be done gradually, and may include hysteresis, to avoid rapid toggling between operational modes.

The control system 100, 200 may be configured to, in dependence on determining that the first subsystem 302 has completed operating in the de-rated mode, transmit a normal operation indicator to the further subsystem 304, 306. The normal operation indicator may be configured to cause the further subsystem 304, 306 to operate in the operating mode it was operating in prior to operating in the de-rate response mode. That is, the further subsystem may be caused, in dependence on receipt of the normal operation indicator, to exit the de-rate response mode and revert to a normal operation mode. The normal operation mode may be based on at least one current vehicle environment parameter in some examples, wherein that at least one current vehicle environment parameter provides an indication that normal operation may resume. The control system 100, 200 may determine the operation mode based on a look-up matrix. The look-up matrix may map the subsystem operating condition of the plurality of subsystems 320, 304, 306 with an adaptive behaviour of each of the plurality of subsystems. The look-up matrix may be the same matrix as the look-up matrix used to determine the de-rate response mode, discussed above. That is, the control system 100, 200 appreciates that driving conditions may have changed since entering the de-rated mode for a subsystem and therefore adapts to the current environment of the vehicle, such that any adaptions in vehicle attributes are made appropriately.

Similarly, when the control system 100, 200 determines that the first subsystem is operating in the de-rated mode by receiving the de-rate indicator from the first subsystem, the control system may be configured to later determine that the first subsystem has completed operating in the de-rated mode by receiving a normal operation indicator, from the first subsystem. As above, the normal operation indicator may indicate that the first subsystem is operating in an operating mode in which the subsystem operating condition of the first subsystem is within the predetermined operating window. The subsystem operation condition of the first subsystem may be comparable to the subsystem operation condition before the de-rate response mode was entered. In some examples, the operating mode of the first subsystem after a de-rated mode may be based on the operating mode of the further subsystem in the suspension system. For example, it may be the case that the further subsystem has started to perform in a de-rate mode when the first subsystem has completed the de-rated mode. Therefore, the first subsystem must adapt to this change such that the further subsystem does not further de-rate (for example until subsystem failure) and/or to improve the availability of the de-rated further subsystem for the duration of the current drive cycle.

The higher level of vehicle control (that is, improved availability of the vehicle suspension system) may comprise the vehicle suspension system operating at one or more of: a reduced power consumption; a reduced temperature; an increased availability of one or more of the subsystems within the plurality of connected subsystems of the vehicle suspension system; and reduced component loads.

The above improvements relate to attributes at the subsystem level. However, such improvements may produce improvements to overall vehicle level attributes. For example, a vehicle body could have reduced roll, heave, and/or pitch rates, or a wheel may have a reduced peak acceleration, in response to subsystem level attributes changing.

The control system 100, 200 may be configured to periodically determine the operating mode of each of the plurality of connected subsystems. In some examples, the control system may be configured to continuously determine the operating mode of each of the plurality of subsystems. That is, the control system may continuously determine an operation mode of the subsystems to ensure that a current operation mode is most appropriate. In such examples, the subsystems may be considered to continuously interact with each other, and adapt as described herein based on each other's operational state. Thus, rather than there being a single fixed de-rate mode which triggers a discrete de-rate response, examples disclosed herein provide an adaptive response system of connected subsystems, based on a level of de-rate (of plurality or a continuum of possible de-rated states of operation) of one or more subsystems at a particular point in time.

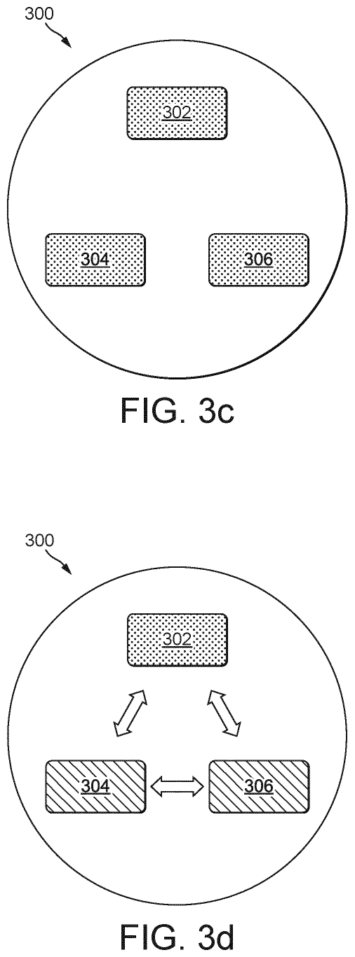

FIGS. 4a and 4b illustrate a scoring method for the overall compromise between different vehicle attributes (“Vehicle Attributes”, FIG. 4a) and the operational availability of the subsystems “Sub-System Availability”, FIG. 4b) in the four scenarios shown in FIGS. 3a-d. In FIG. 4a, if all the subsystems are operating in a normal condition 402a then the vehicle operation is at a high level; that is, the design intent compromise between vehicle attributes in normal mode may be met. If a subsystem operates in a derated state without any effect on the other subsystems 404a as in FIG. 3b then the vehicle operation is at a medium level; that is, the compromise between the different vehicle attributes may be degraded. If the other subsystems then also operate in a derated state in response to the first derated subsystem 406a as in FIG. 3c then the vehicle operation is at a low level; that is, the compromise between the different vehicle attributes may be more severely degraded. If, according to examples disclosed herein as in FIG. 3d, the other subsystems then also operate in a derate response mode in response to the first derated subsystem 408a then the vehicle operation is at a high level; that is, the compromise between the different vehicle attributes may be only marginally (i.e. very slightly) degraded, better than in the scenarios in which there is no intercommunication between the subsystems.

In FIG. 4b showing sub-system availability, if all the subsystems are operating in a normal condition 402b then the sub-system availability is low (due to the sub-systems operating to deliver a maximum individual performance). If a subsystem operates in a de-rated state without any effect on the other subsystems 404b as in FIG. 3b then the sub-system availability is at a medium level due to the de-rate state of the first subsystem. If the other subsystems then also operate in a de-rated state in response to the first derated subsystem 406b as in FIG. 3c then the sub-system availability is at a high level because all of the subsystems may be de-rated. However, there may be a cost of the vehicle attribute because the subsystems are de-rate. If, according to examples disclosed herein as in FIG. 3d, the other subsystems then also operate in a de-rate response mode in response to the first derated subsystem 408b then the sub-system availability is at the highest level, better than in the scenarios in which there is no intercommunication between the subsystems. This is because, by entering the de-rate response mode, the other subsystems are able to help prevent the first subsystem from having to further de-grade its own performance (and thus prevent a reduction in subsystem availability), whilst still ensuring that the vehicle attribute is optimised.

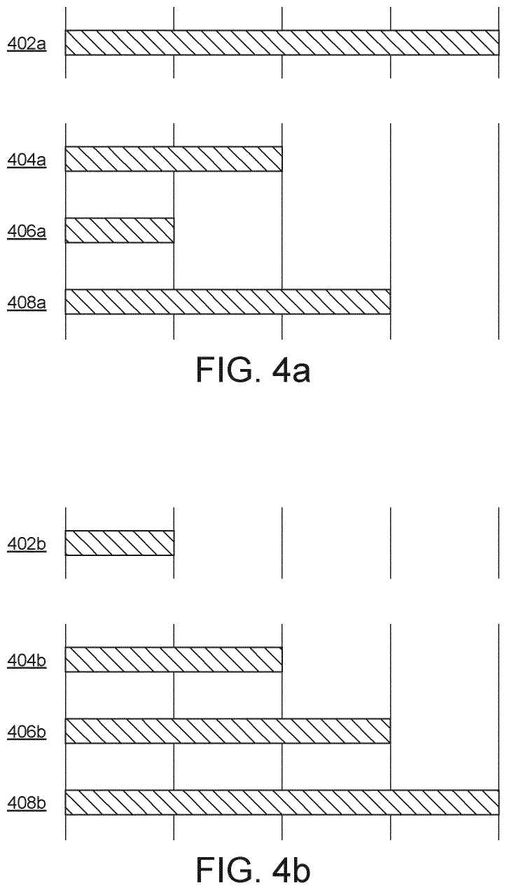

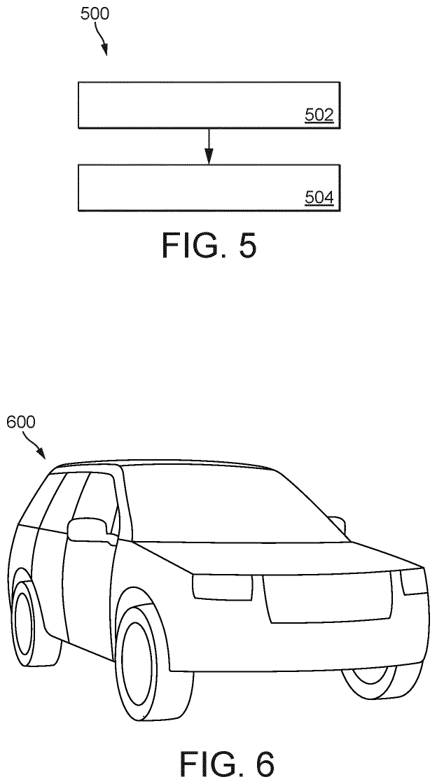

FIG. 5 shows a method 500 of a control system 100, 200 for a vehicle suspension system of a vehicle, such as the vehicle 600 in FIG. 6. The control system as discussed above comprises one or more controllers and the vehicle suspension system comprises one or more actuator subsystems.

The method 500 may be performed by the control system 100, 200 illustrated in FIG. 1. In particular, the memory 130 may comprise computer-readable instructions which, when executed by the processor 120, perform the method 500 according to an embodiment of the invention. The blocks illustrated in FIG. 5 may represent steps in a method 500 and/or sections of code in a computer program configured to control the control system as described above to perform the method steps. The illustration of a particular order to the blocks does not necessarily imply that there is a required or preferred order for the blocks and the order and arrangement of the blocks may be varied. Furthermore, it may be possible for some steps to be omitted or added in other examples. Therefore, this disclosure also includes computer software that, when executed, is configured to perform any method disclosed herein, such as that illustrated in FIG. 5. Optionally the computer software is stored on a computer readable medium, and may be tangibly stored.

The method 500 comprises: determining 502 that a first subsystem of a plurality of connected subsystems of a suspension system in a vehicle is operating in a de-rated mode in response to a subsystem operating condition of the first subsystem being outside a predetermined operating window; and in dependence on determining that the first subsystem is operating in the de-rated mode, transmitting 504 a de-rate indicator to a further subsystem of the plurality of connected subsystems, wherein the de-rate indicator is configured to: indicate, to the further subsystem, that the first subsystem is operating in a de-rated mode; and cause the further subsystem to operate in a de-rate response mode, wherein the operation of the vehicle suspension system with the first subsystem operating in the de-rated mode and the further subsystem operating in the de-rate response mode provides a higher level of vehicle control in comparison to the vehicle suspension system operating with the first subsystem operating in the de-rated mode without the further subsystem operating in the de-rate response mode. A higher level of vehicle control may comprise improved availability of vehicle suspension subsystems. In some examples, the method may comprise the de-rate indicator further indicating to the further subsystem which de-rate mode of a plurality of available de-rate modes the first subsystem is operating in, thus causing the further subsystem to operate in a de-rate response mode in accordance with the de-rate mode in which the first subsystem is operating in.

FIG. 6 illustrates a vehicle 600 according to an embodiment of the invention. The vehicle 600 in the present embodiment is an automobile, such as a wheeled vehicle, but it will be understood that the control system 100, 200 and active suspension system may be used in other types of vehicle.

It will be appreciated that various changes and modifications can be made to the examples disclosed herein without departing from the scope of the present application as defined by the appended claims.

As used here ‘module’ refers to a unit or apparatus that excludes certain parts/components that would be added by an end manufacturer or a user.

As used here, ‘connected’ means “electrically interconnected” and/or “mechanically interconnected” either directly or indirectly. Electrical interconnection does not have to be galvanic. Where the control system is concerned, connected means operably coupled to the extent that messages are transmitted and received via the appropriate communication means.

Although examples have been described in the preceding paragraphs with reference to various examples, it should be appreciated that modifications to the examples given can be made without departing from the scope of the invention as set out in the appended claims. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

Whilst endeavouring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

1-15. (canceled)

16. A control system for a vehicle suspension system in a vehicle, the vehicle suspension system comprising a plurality of connected subsystems, the control system comprising one or more controllers, the control system configured to:
determine that a first subsystem of the plurality of connected subsystems is operating in a de-rated mode in response to a subsystem operating condition of the first subsystem being outside a predetermined operating window; and
in dependence on determining that the first subsystem is operating in the de-rated mode, transmit a de-rate indicator to a further subsystem of the plurality of connected subsystems, wherein the de-rate indicator is configured to:
indicate, to the further subsystem, that the first subsystem is operating in a de-rated mode; and
cause the further subsystem to operate in a de-rate response mode, wherein the operation of the vehicle suspension system with the first subsystem operating in the de-rated mode and the further subsystem operating in the de-rate response mode provides a higher level of vehicle control in comparison to the vehicle suspension system operating with the first subsystem operating in the de-rated mode without the further subsystem operating in the de-rate response mode.

17. The control system of claim 16, wherein the control system is configured to cause the further subsystem to operate in a de-rate response mode by:
determining at least one subsystem operating window for the further subsystem wherein the further subsystem, operating in dependence on the at least one subsystem operating window, operates in the de-rate response mode; and
providing the at least one subsystem operating window to the further subsystem to cause the further subsystem to operate in the de-rated response mode according to the subsystem operating window.

18. The control system of claim 17, wherein the control system is configured to determine the at least one subsystem operating window by identifying the at least one subsystem operating window in a look-up matrix,
wherein the look-up matrix indicates, for at least one de-rated mode of the first subsystem, a corresponding subsystem operating window for provision to the further subsystem to cause the further subsystem to operate in the de-rate response mode.

19. The control system of claim 16, wherein the control system is configured to determine the at least one subsystem operating window in dependence on at least one vehicle environment parameter, indicating one or more of:
a driving surface type on which the vehicle is located;
an operating temperature of the vehicle suspension system; and
an operating electrical condition of the vehicle suspension system;

20. The control system of claim 16, wherein the control system is configured to cause the further subsystem to operate in a de-rate response mode causing the further subsystem to change operation mode to gradually operate in the de-rate response mode over a period of time.

21. The control system of claim 16, wherein the control system is configured to:
determine that the first subsystem has completed operating in the de-rated mode in response to a subsystem operating condition of the first subsystem being within the predetermined operating window; and
in dependence on determining that the first subsystem has completed operating in the de-rated mode, transmit a normal operation indicator to the further subsystem, wherein the normal operation indicator is configured to cause the further subsystem to operate in the operating mode it was operating in prior to operating in the de-rate response mode.

22. The control system of claim 16, wherein the control system is configured to determine that the first subsystem is operating in the de-rated mode by receiving a de-rate indicator from the first subsystem, the de-rate indicator indicating that the subsystem operating condition of the first subsystem is outside a predetermined operating window,
optionally wherein the control system is configured to determine that the first subsystem has completed operating in the de-rated mode by receiving a normal operation indicator, from the first subsystem, indicating the first subsystem is operating in an operating mode in which the subsystem operating condition of the first subsystem is within the predetermined operating window.

23. The control system of claim 16, wherein the higher level of vehicle control comprises the vehicle suspension system operating at one or more of:
reduced power consumption;
reduced temperature;
increased availability of one or more of the subsystems within the plurality of connected subsystems of the vehicle suspension system; and
reduced component loads.

24. The control system of claim 16, wherein the control system is configured to periodically determine the operating mode of each of the plurality of connected subsystems.

25. The control system of claim 16, wherein the plurality of connected subsystems comprise at least one electronic control module, and at least one mechatronic component.

26. The control system of claim 16, wherein one or more of the first subsystem and the further subsystem are:
an electronic active roll control system of the vehicle suspension system;
an active damping system of the vehicle suspension system;
a rear wheel steering system of the vehicle; and
an active springs system of the vehicle suspension system.

27. The control system of claim 16, wherein the control system is configured to cause the further subsystem to operate in a de-rate response mode by:
providing a de-rate response mode indicator to the further subsystem, wherein the de-rate response mode indicator indicates, to the further subsystem, that the further subsystem is to change operation mode to operate in the de-rate response mode and that one or more of the control system and the further subsystem is to determine a subsystem operating window to achieve in the de-rate response mode.

28. A method, comprising:
determining that a first subsystem of a plurality of connected subsystems of a suspension system in a vehicle is operating in a de-rated mode in response to a subsystem operating condition of the first subsystem being outside a predetermined operating window; and
in dependence on determining that the first subsystem is operating in the de-rated mode, transmitting a de-rate indicator to a further subsystem of the plurality of connected subsystems, wherein the de-rate indicator is configured to:
indicate, to the further subsystem, that the first subsystem is operating in a de-rated mode; and
cause the further subsystem to operate in a de-rate response mode, wherein the operation of the vehicle suspension system with the first subsystem operating in the de-rated mode and the further subsystem operating in the de-rate response mode provides a higher level of vehicle control in comparison to the vehicle suspension system operating with the first subsystem operating in the de-rated mode without the further subsystem operating in the de-rate response mode.

29. Computer readable instructions configured to perform the method of claim 28.

30. A vehicle comprising a control system according to claim 16.
